(19) United States
(12) Patent Application Publication
(10) Pub. No.: US 2005/0083267 A1
(43) Pub. Date: Apr. 21, 2005

(54) Method of manufacturing flat display

(76) Inventors: Junko Yotani, Aichi (JP); Sashiro Uemura, Aichi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/969,284

(22) Filed: Oct. 19, 2004

(30) Foreign Application Priority Data
Oct. 20, 2003 (JP) 359476/2003

(51) Int. Cl. G09G 3/20; G09G 3/22

(52) U.S. Cl. 345/75.2

(57) ABSTRACT

In a method of manufacturing a control electrode structure for a flat display that uses a field emission type electron source, a field control electrode is formed on one surface of an insulating substrate, a control electrode is formed on the other surface of the insulating substrate, and an insulating layer is formed on the control electrode. After the field control electrode, insulating substrate, control electrode, and insulating layer are formed, an electron-passing hole is formed at once which extends through the field control electrode, insulating substrate, control electrode, and insulating layer which are stacked on each other.

### BACKGROUND OF THE INVENTION

The present invention relates to a method of manufacturing a flat display in which field emission type electron emission is controlled and, more particularly, to a method of manufacturing a control electrode structure for a flat display that uses a field emission type electron source.

In recent years, as a flat panel display such as a FED (Field Emission Display) or a flat vacuum fluorescent display in which electrons emitted from an electron-emitting source serving as a cathode are collided against a light-emitting portion formed of phosphors on a counter-electrode to emit light, various types that use nanotube fibers, e.g., carbon nanotubes or carbon nanofibers, as the electron-emitting source (CNT) have been proposed. As such a flat display using nanotube fibers as the electron-emitting source (CNT), one has been proposed in which an insulating substrate having electron-passing holes is arranged on a cathode formed with nanotube fibers and a control electrode which controls electron emission of the cathode is arranged on the insulating substrate.

FIG. 3 is a partially exploded view showing an example of a flat display of this type. This flat display has a substrate 101 made of glass or the like and a front glass plate 103 which is at least partly transparent. The substrate 101 and front glass plate 103 are arranged to oppose each other through a spacer glass frame (not shown), and are adhered to the spacer glass frame with low-melting frit glass to form an envelope. The interior of the envelope is held at a vacuum degree on the order of 10⁻⁵ Pa. A control electrode structure 120 is disposed in the envelope such that the control electrode structure 120 is substantially parallel to the substrate 101 and front glass plate 103 and is spaced apart from them at a predetermined distance.

A plurality of substrate ribs 102 vertically extend from one surface of the substrate 101 to be parallel to each other at predetermined intervals. Band-like cathodes 110, to the surfaces of which nanotube fibers are fixed as an electron-emitting source (CNT), are arranged in regions sandwiched by the substrate ribs 102 on the substrate 101, such that the cathodes 110 are almost the same height as that of the substrate ribs 102.

A plurality of front ribs 104 vertically extend from that surface of the front glass plate 103 which opposes the substrate 101, in a direction perpendicular or parallel to the substrate ribs 102 and cathode 110, at predetermined intervals. Band-like phosphor screens 105B, 105G, and 105R are arranged in those regions of the front glass plate 103 which are sandwiched by the front ribs 104. Metal-backed films 106 to serve as anodes are formed on those surfaces of the phosphor screens which oppose the substrate 101.

The control electrode structure 120 is arranged in the envelope, and is located between the substrate ribs 102 on the substrate 101 and the front ribs 104 of the front glass plate 103 to be separate from them.

Electron-passing holes 125, through which a field control electrode 122, insulating layer 121, control electrodes 123, and an insulating layer 124 communicate with each other, are formed in those regions of the control electrode structure 120 where the control electrodes 123 and cathodes 110 intersect.

The control electrode structure 120 includes the insulating layer 121, field control electrode 122 disposed on the front glass plate 103 side surface of the insulating layer 121, the band-like control electrodes 123 formed on the substrate 101 side surface of the insulating layer 121 in one-to-one correspondence with the phosphor screens 105B, 105G, and 105R, and the insulating layer 124 formed on the substrate 101 side surface of the insulating layer 121 so as to cover the control electrodes 123.

In this flat display, a predetermined potential difference is formed between the control electrode structure 120 and cathodes 110 such that the control electrode structure 120 side has a positive potential. Hence, electrons extracted from the intersecting regions of the cathodes 110 and control electrodes 123 are emitted through the electron-passing holes 125. When a positive potential (accelerating voltage) is applied to the metal-backed films 106, the electrons emitted from the electron-passing holes 125 are accelerated toward the metal-backed films 106, travel through the metal-backed films 106, and collide against the phosphor screens 105B, 105G, and 105R, so that the phosphor screens 105B, 105G, and 105R emit light.

In this flat display, a conventional control electrode structure is manufactured in the following manner. For example, a glass substrate printed with a separation layer is used as a workbench. An insulating layer 124′, control electrodes 123′, insulating layer 121′, and field control electrode 122′ are printed on the glass substrate in an overlapping manner at portions corresponding to electron-passing holes 125′ by using a screen having the pattern of the electron-passing holes 125′, and are calcined. If printing is performed from the field control electrode 122′ side, the insulating layers 121′ and 124′ may sag on the field control electrode 122′ and control electrodes 123′ to cover the respective electrodes. If printing is performed considering sagging, the control electrodes 123′ and an electron-emitting source (CNT) may undesirably come into contact with each other. Therefore, conventionally, the manufacture should not but be started from the insulating layer 124′ side, and the electron-passing holes 125′ are formed to gradually enlarge toward the anode electrode. In other words, a control electrode structure 120′ having a sectional structure as shown in FIG. 4 is formed. This corresponds to, e.g., Japanese Patent Laid-Open No. 2002-343281. FIG. 4 is a sectional view of a conventional control electrode structure.

With the conventional manufacturing method of the control electrode structure 120′ as described above, when printing the respective layers, openings to form the electron-passing holes 125′ are also formed simultaneously. Accordingly, as shown in FIG. 4, sagging, blur, or the like A of the printed paste occurs on the surface of each electron-passing hole 125′, that is, on the surfaces of the respective layers of the control electrode structure 120′ that forms each electron-passing hole 125′. The sagging, blur, or the like A forms irregularities on the surface of the electron-passing hole 125′ to adversely affect the field strength between the corresponding cathode 110 and control electrode structure 120′. In particular, if the diameter of the opening of the control electrode 123′ becomes smaller than that of the opening of the adjacent insulating layer 121′ or 124′ due to the sagging, blur, or the like A, the control electrode structure 120′ becomes less influenced by the electric field. Then, the field strength in the vicinity of the cathode 110 cannot be increased, and electrons cannot be extracted from the cathode 110 effectively. As a result, the uniformity of the brightness of the flat display decreases. To obtain a considerably high brightness, the driving voltage must be increased. Also, a structure in which the opening enlarges toward the anode electrode side tends to be influenced by the anode electrode easily, and may sometimes discharges upon charge-up of the surface of the insulating layer 121′.

### SUMMARY OF THE INVENTION

It is, therefore, a principal object of the present invention to provide a method of manufacturing a control electrode structure for a flat display that uses a field emission type electron source, in which electron-passing holes can be formed in the flat display uniformly without causing sagging, blur, or the like and which is less influenced by an anode voltage.

It is another object of the present invention to provide a method of manufacturing a control electrode structure for a flat display, in which a flat display manufacturing process can be simplified.

In order to achieve the above objects, according to the present invention, there is provided a method of manufacturing a control electrode structure for a flat display that uses a field emission type electron source, comprising the steps of forming a field control electrode on one surface of an insulating substrate, a control electrode on the other surface of the insulating layer, and an insulating layer on the control electrode, and after the field control electrode, insulating substrate, control electrode, and insulating layer are formed, forming at once an electron-passing hole which extends through the field control electrode, insulating substrate, control electrode, and insulating layer which are stacked on each other.

### BRIEF DESCRIPTION OF THE DRAWINGS

FIGS. 1A to 1D are views showing a process of manufacturing a control electrode structure for a flat display that uses a field emission type electron source according to the present invention;

FIG. 2 is a sectional view of the control electrode structure to explain a method of manufacturing the control electrode structure for the flat display according to the present invention;

FIG. 3 is a partially exploded view showing an example of a flat display that uses a field emission type electron source manufactured by the present invention; and

FIG. 4 is a sectional view of a control electrode structure for a conventional flat display.

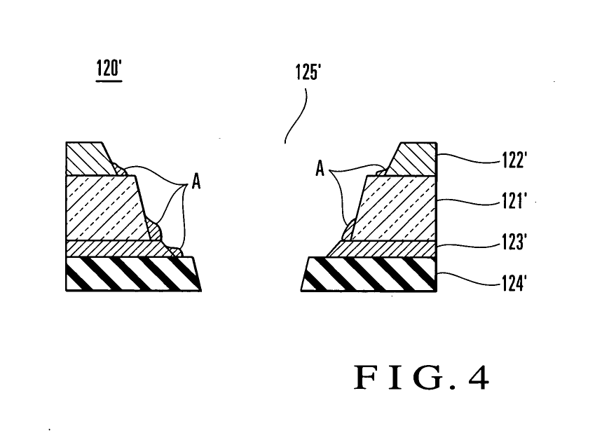

### DESCRIPTION OF THE PREFERRED EMBODIMENT

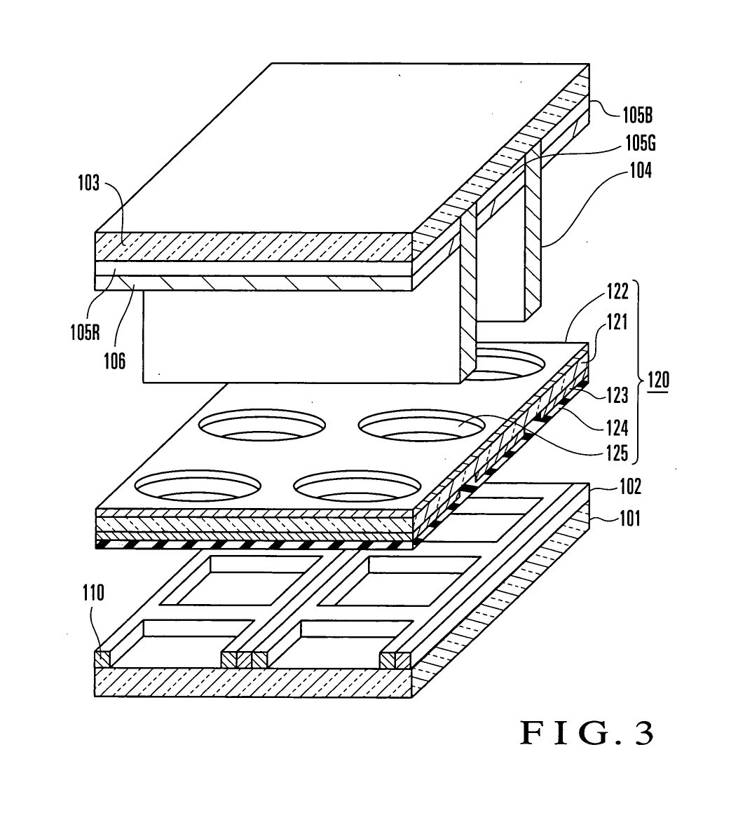

An embodiment of a control electrode structure for a flat display that uses a field emission type electron source according to the present invention will be described in detail with reference to the accompanying drawings. The control electrode structure manufactured with the present invention is used for a flat display that uses the field emission type electron source described with reference to FIG. 3.

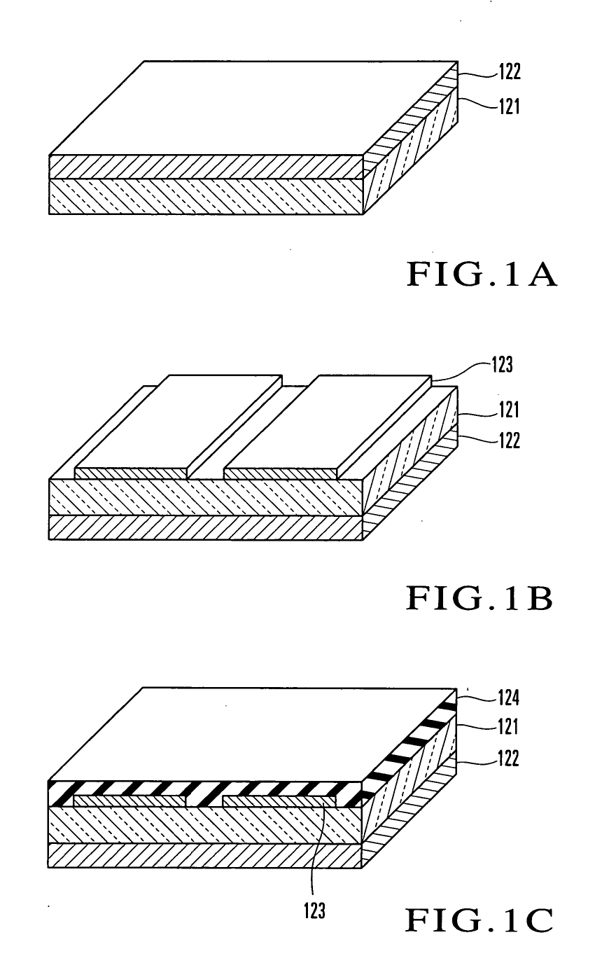

First, the arrangement of the control electrode structure to be manufactured with a method of manufacturing a control electrode structure that uses a field emission type electron source according to this embodiment will be described with reference to FIGS. 1A to 1D and FIG. 3. FIGS. 1A to 1D are views showing a process of manufacturing the control electrode structure for the flat display according to this embodiment.

As shown in FIGS. 1D and 3, a control electrode structure 120 includes a glass substrate 121, field control electrode 122, control electrodes 123, and insulating layer 124. The field control electrode 122 is arranged on that surface of the glass substrate 121 which opposes a front glass plate 103. The band-like control electrodes 123 are formed on that surface of the glass substrate 121 which opposes a substrate 101, in one-to-one correspondence with phosphor screens 105B, 105G, and 105R on the front glass plate 103. The insulating layer 124 is formed on the substrate 101 side surface of the glass substrate 121 so as to cover the control electrodes 123. Electron-passing holes 125, through which the field control electrode 122, glass substrate 121, control electrodes 123, and insulating layer 124 communicate with each other, are formed in those regions of the control electrode structure 120 where the band-like control electrodes 123 and cathodes 110 intersect.

In this case, the glass substrate 121 suffices as far as it is made of a material that hardly deforms or denatures during heating. For example, a glass substrate having a thickness of about 150 μm to 500 μm and made of borosilicate-based non-alkali glass or soda-lime glass is used.

The field control electrode 122 is formed on the entire portion of that surface of the glass substrate 121 which opposes the front glass plate 103. With the field control electrode 122, the control electrodes 123 and the cathodes 110 to which nanotube fibers are fixed as the electron-emitting source can be sealed electrically. At a region where the field control electrode 122 is formed, no electric field is generated by a potential difference between the cathodes 110 and metal-backed films 106 serving as anode electrodes, so that damage caused by field concentration on the electron-emitting source can be prevented. Although the field control electrode 122 is formed on the entire surface of the glass substrate 121 in the above embodiment, it can naturally be formed as a mesh.

The control electrodes 123 are arranged, on that surface of the glass substrate 121 which opposes the substrate 101, in the form of bands corresponding in number to the pixel arrays of the flat display, in a direction perpendicular to the cathodes 110 to be substantially parallel to each other. Spaces may be reserved, if necessary, between the arranged control electrodes 123.

The insulating layer 124 is made of, e.g., a glass ceramic material mixed with a glass material, chromium oxide, or the like which has a low secondary electron emission ratio, and is formed on the glass substrate 121 to cover the control electrodes 123, such that the thickness of the insulating layer 124 is, e.g., several ten μm to several hundred μm. The collision area where the electrons collide against the phosphor screens 105B, 105G, and 105R changes depending on the thickness of the insulating layer 124. For example, if the distance between the anode and the control electrodes 123 is constant, the larger the thickness of the insulating layer 124, the more the electrons passing through the control electrode structure 120 converge, and the narrower their collision area.

The electron-passing holes 125 are formed in the regions where the control electrodes 123 and cathodes 110 intersect. Electrons emitted from the electron-emitting source of the cathodes 110 pass through the electron-passing holes 125, and are accelerated toward the metal-backed films 106.

A method of manufacturing the control electrode structure 120 according to this embodiment will be described with reference to FIGS. 1A to 1D.

First, a flat glass substrate 121 having a thickness of about 200 μm is prepared. As shown in FIG. 1A, a field control electrode 122 made of a conductive paste containing silver or carbon as a conductive material is formed by screen printing on the entire surface of the glass substrate 121 to a thickness of, e.g., about several ten μm with an appropriate pattern. The field control electrode 122 is then dried and calcined.

As shown in FIG. 1B, control electrodes 123 made of a conductive paste containing silver or carbon as a conductive material and having a short-side-direction length of about several μm to several hundred μm in accordance with the pixel pitch are formed by screen printing on that surface of the glass substrate 121 which is opposite to the surface where the field control electrode 122 is formed, in a direction perpendicular to the cathodes 110 described above, in the form of bands corresponding in number to the rows of the flat display, to be substantially parallel to each other. The control electrodes 123 are then dried.

As shown in FIG. 1C, an insulating layer 124 is formed to a thickness of, e.g., 20 μm, on the glass substrate 121 formed with the control electrodes 123. The insulating layer 124 is then dried and calcined.

Regarding the field control electrode 122, control electrodes 123, and insulating layer 124 to be formed on the respective surfaces of the glass substrate 121, the control electrodes 123 and insulating layer 124 may be formed first, and after that the field control electrode 122 may be formed.

Electron-passing holes 125 are formed at once in a control electrode structure 120 including the field control electrode 122, glass substrate 121, control electrodes 123, and insulating layer 124. For example, assume that the electron-passing holes 125 are to be formed by sandblasting. A resist material is applied to the insulating layer 124. The resist material is patterned to form a resist mask having holes at portions corresponding to the electron-passing holes 125. Alumina particles having a diameter of about 3 μm to 30 μm are blown like shower from the resist mask side toward the control electrode structure 120 at 50 m/sec to 100 m/sec. The alumina particles grind the respective constituent elements of the control electrode structure 120 exposed from the holes formed in the resist mask, so that the electron-passing holes 125 as shown in FIG. 1D are finally formed. Each electron-passing hole 125 has a diameter of, e.g., about 0.05 mm to 0.5 mm considering the pixel size.

In this case, the electron-passing hole 125 is formed in the control electrode structure 120 substantially as a frustum of right circular cone to gradually taper toward the anode electrode, in other words, to gradually enlarge with respect to the electron-emitting source, so that an electric field uniformly acts on the electron-emitting source (CNT). If the electron-passing hole 125 does not taper but is formed merely perpendicularly, an electric field acts on only a limited portion (where the electron-emitting source and control electrode are closest) of the electron-emitting source (CNT). Then, local electron emission occurs leading to non-uniform electron emission.

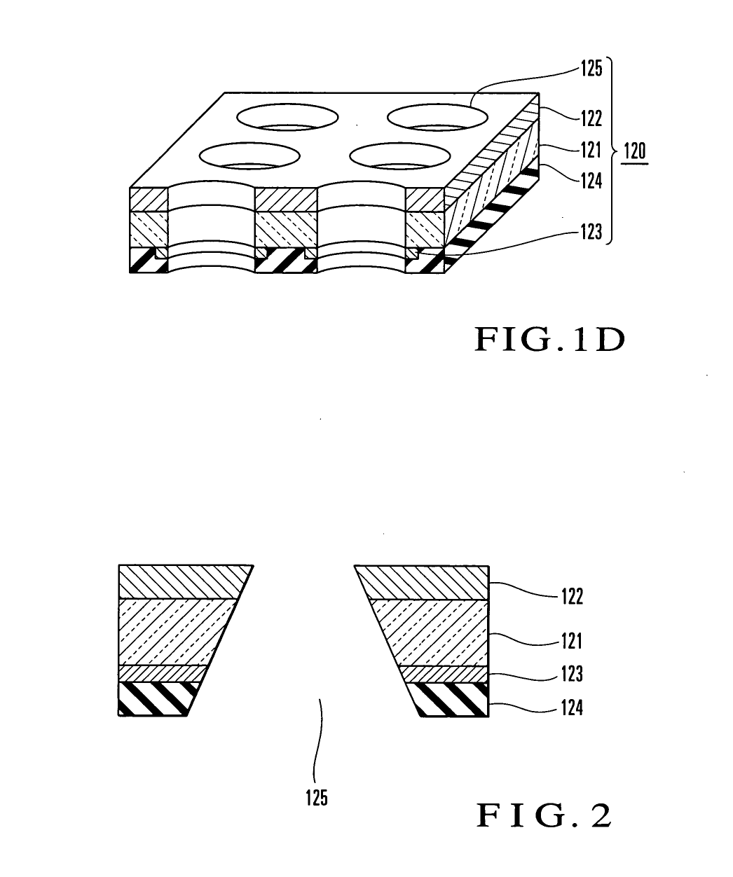

The sectional view of the control electrode structure 120 formed in accordance with this method is shown in FIG. 2. FIG. 2 shows the section of the control electrode structure 120 according to this embodiment.

According to this embodiment, the field control electrode 122, control electrodes 123, and insulating layer 124 are formed on the glass substrate. After that, the electron-passing holes 125, through which the field control electrode 122, glass substrate 121, gate electrodes 123, and insulating layer 124 communicate with each other, are formed. Therefore, unlike in the conventional case, sagging, blur, or the like does not occur on the side surface of the electron-passing hole 125, and the side surface of the electron-passing holes 125 is formed smooth (flat), as often shown in FIG. 2. An electric field can thus be effectively applied to the electron-emitting source such as carbon nanotubes attaching to the cathodes 110, and electrons can be extracted from the cathodes 110 effectively. As a result, the uniformity of the brightness of the flat display increases, and a decrease in driving voltage can be realized. As the electron-passing holes are formed at once, the manufacturing process is simplified compared to the conventional manufacturing process, and the cost of the control electrode structure is decreased, so that the flat display can be manufactured at a low cost.

According to this embodiment, as the electron-passing holes 125 are formed from the insulating layer 124 side by sandblasting, each electron-passing hole 125 is formed substantially as a frustum of right circular cone the diameter of which gradually increases from the field control electrode 122 side toward the insulating layer 124 side. Because of this smooth shape, the shield effect and field application effect for the electrodes formed under the field control electrode 122 and the surface of the insulator are enhanced. Thus, the control electrode structure 120 can apply an electric field to the cathodes 110 effectively.

The method of forming the electron-passing holes 125 is not limited to sandblasting described above, but the electron-passing holes 125 can be formed by, e.g., etching or laser irradiation. These methods will be described hereinafter.

Assume that the electron-passing holes 125 are to be formed by etching. A resist material is applied to an insulating layer 124 of a control electrode structure 120 shown in FIG. 1C. The resist material is patterned to form a resist mask having holes at portions corresponding to the electron-passing holes 125. The resultant structure is dipped in an etching solution obtained by appropriately mixing hydrofluoric acid and ammonium fluoride. The electron-passing holes 125 as shown in FIG. 1D are then formed in the control electrode structure 120. The resist material may be applied to the two surfaces of the control electrode structure 120, that is, to the insulating layer 124 side surface and the field control electrode 122 side surface of the control electrode structure 120.

Assume that the electron-passing holes 125 are to be formed by laser irradiation. The control electrode structure 120 shown in FIG. 1C is irradiated from its insulating layer 124 side with an Nd:YAG laser, CO₂ laser, or excimer laser (KrF or the like) having an appropriately adjusted output. Then, the electron-passing holes 125 as shown in FIG. 1D are formed in the control electrode structure 120.

When the electron-passing holes 125 are formed by etching or laser irradiation described above, the same function and effect as in a case wherein the electron-passing holes 125 are formed by sandblasting can be obtained.

According to the present invention, the electron-passing holes are formed after the field control electrode, control electrodes, and insulating layer are formed on a flat glass substrate that uses a field emission type electron source. Thus, unlike in the conventional case, sagging, blur, or the like does not occur on the side surface of each electron-passing hole, and the respective surfaces and the side surface of each electron-passing hole are formed smooth. Consequently, the distances between the cathodes and control electrodes can be formed more uniform than in the conventional case, and the cathodes and control electrodes are formed close to each other. An electric field can thus be applied effectively to the electron-emitting source such as carbon nanotubes attaching to the cathodes. Therefore, electrons can be extracted from the cathodes effectively. Consequently, the uniformity of the brightness of the flat display increases, and a decrease in driving voltage can be realized.

1. A method of manufacturing a control electrode structure for a flat display that uses a field emission type electron source, comprising the steps of:
forming a field control electrode on one surface of an insulating substrate, a control electrode on the other surface of the insulating substrate, and an insulating layer on the control electrode; and
after the field control electrode, insulating substrate, control electrode, and insulating layer are formed, forming at once an electron-passing hole which extends through the field control electrode, insulating substrate, control electrode, and insulating layer which are stacked on each other.

2. A method according to claim 1, wherein the electron-passing hole is formed by one method selected from sandblasting, etching, and laser irradiation.

3. A method according to claim 1, wherein the electron-passing hole substantially has a shape of a frustum of right circular cone a diameter of which gradually increases from a field control electrode side toward a control electrode side.

4. A method according to claim 1, wherein a side surface of the electron-passing hole is formed flat.

5. A method according to claim 1, wherein the insulating layer is made of a glass ceramic material mixed with a material having a low secondary electron emission ratio.
